(19) United States
(12) Patent Application Publication
(10) Pub. No.: US 2008/0059489 A1
(43) Pub. Date: Mar. 6, 2008

(54) Method for parallel query processing with non-dedicated, heterogeneous computers that is resilient to load bursts and node failures

(75) Inventors: Wei Han, San Francisco, CA (US); Inderpal Singh Narang, Saratoga, CA (US); Vijayshankar Raman, San Jose, CA (US)

Correspondence Address: SCULLY SCOTT MURPHY & PRESSER, PC, 400 GARDEN CITY PLAZA, SUITE 300, GARDEN CITY, NY, 11530, US

(73) Assignee: International Business Machines Corporation, Armonk, NY (US)

(21) Appl. No.: 11/512,769

(22) Filed: Aug. 30, 2006

(51) Int. Cl. G06F 7/00

(52) U.S. Cl. 707/100

(57) ABSTRACT

A method is provided for query processing in a grid computing infrastructure. The method entails storing data in a data storage system accessible to a plurality of computing nodes. Computationally-expensive query operations are identified and query fragments are allocated to individual nodes according to computing capability. The query fragments are independently executed on individual nodes. The query fragment results are combined into a final query result.

### FIELD OF THE INVENTION

This invention relates to a method for query processing in a grid computing infrastructure, and more particularly, to storing data in a data storage system accessible to a plurality of individual computing nodes which individually execute query fragments.

### BACKGROUND OF THE INVENTION

Typically, the method of parallel query processing uses partitioned parallelism, where data is carefully partitioned across a cluster of machines, and each machine executes a query over its data partition (with some data exchange). Generally, parallel computing is the simultaneous execution of the same task (split up and specially adapted) on multiple processors. Parallel computing may use parallel programming to partition an overall problem or query into separate tasks, and then allocate the tasks to processors and synchronize the tasks to generate desired results.

A problem with partitioned parallelism occurs when a new processor becomes available to extend a cluster of computers (computer nodes), extending the cluster to exploit the new resource (computer node) is a highly manual process which requires user interface and time. For example, the data needs to be re-partitioned, loaded into the database management system (DBMS) on the new processor, and indexes must be created. A database management system (DBMS) is a computer program (or more typically, a suite of them) designed to manage a database, and run operations on the data requested by numerous clients.

Thus, it is difficult to exploit the resources of shared machines, and almost impossible to exploit transiently available machines (as in Grid Computing infrastructure), for example, a user workstation that is available only when the user is not logged on. Grid computing uses many networked computers to model a virtual computer architecture that is able to distribute process execution across a parallel computing infrastructure.

Re-partitioning might also involve quiescing the DBMS, and thereby adversely affect the application. Using quiescing slows down a computer to save power while the computer remains available and the quiescing process may include shutting down some services. A Quiesce menu option can be used to immediately force all users off a database. Use of a Quiesce menu option may also be used to force specified users or a group of users off a database while another group of users may be left on the database.

Currently, homogeneous clusters are used in a cluster based parallel query system. In a homogeneous cluster all computer nodes run the same query plan. For example, using Exchange™ (also called TQ), operators between joins ensures that each node joins a disjoint partition of the data. A join combines records from two or more tables in a relational database. In a Structured Query Language (e.g., SQL), there are three types of joins: inner, outer, and cross.

The use of an identical query plan is sub-optimal on nodes with different hardware configurations. For example, a hash join may be better on a newer node with more memory because the hash join can be done in one pass, whereas an index join may be better on an older node. A Hash Join is an example of a join algorithm and is used in the implementation of a relational database management system. Hash Join and an Index Join are two methods for performing a join. A database management system (DBMS) executes a SQL query by combining a number of join operators into a query plan. The component of the DBMS that chooses the query plan is commonly called query optimizer.

The basic problem of a join algorithm is to find, for each distinct value of the join attribute, the set of tuples in each relation which display that value. In database theory, a tuple is usually defined as a finite function that maps field names to a certain value. Its purpose is the same as in mathematics, namely to indicate that a certain entity or object consists of certain components and/or has certain properties. The components are typically identified by a unique field name and not by a position. Each table in a database contains a collection of records, which can also be called tuples.

Moreover, the join algorithm plan and tuple exchange requires homogeneous clusters, and implies that all the nodes must run the same DBMS software and version. Typically, in programming languages, a tuple is a data object that holds several objects, similar to a mathematical tuple, and the object is also known as a record. Other systems perform joins by shipping tuples between the processing nodes so that they have the heterogeneity and fault-tolerance limitations. One disadvantage with this method is that the query process is limited by the processing speed of the slowest node. This hinders incremental growth of the cluster because the DBA (Database Administrator) must either keep buying the outdated version of the DBMS, or upgrade the whole cluster. Typically, a set of nodes to which, for example, ExchangeTM sends tuples is determined beforehand, and cannot be changed once the exchange starts. If one of the chosen nodes has even a transient stall, skew, load burst, or failure, the entire query is affected.

Other systems allocate query processing work to grid compute nodes using intra-operator parallelism. The system may use Exchange™ operators, and chooses the degree of parallelism of each Exchange™ operator in a cost-based fashion. The disadvantage of this approach is that even though grid compute nodes are used, the system still uses intra-operator parallelism which exchanges tuples between plan operators, and thus has the same heterogeneity and load/failure resiliency problems as the homogeneous clusters discussed above.

Another problem with current systems of parallel query processing is that non-dedicated compute resources are not utilized and thus possible computing resources are wasted. A further problem with current systems of parallel query processing occurs when using heterogeneous compute resources by parallelizing at the intra-operator or inter-operator granularity. A disadvantage of this approach is that the query processing is limited by the slowest compute node.

It would therefore be desirable for a query processing system to run a query in parallel without any re-partitioning and without any tuple shipping between join operators.

### BRIEF DESCRIPTION OF THE DRAWING

These and other objects, features and advantages of the present invention will become apparent from the following detailed description of illustrative embodiments thereof, which is to be read in connection with the accompanying drawing, in which:

FIG. 1 is a flowchart depicting the Data In The Network” (DITN) system architecture including a cpuwrapper and co-processors according to an embodiment of the invention.

### SUMMARY OF THE INVENTION

In an aspect of the present invention, a method for query processing in a grid computing infrastructure comprises storing data in a data storage system accessible to a plurality of individual computing nodes. Specified query operations are identified, and query fragments are allocated of a specified query operation to the individual computing nodes according to each of the individual computing nodes computing capability. The query fragments on the individual computing nodes are independently executed in parallel to increase speed of query execution and then the query fragment results are combined into a final query result.

In a related aspect of the invention the method further comprises monitoring the computational performance of the individual computing nodes, and selectively reassigning the query fragments to particular individual computing nodes according to changes in performance of the monitored nodes.

In a related aspect of the invention the individual computing nodes include non-dedicated heterogeneous computing nodes each running different database applications.

In a related aspect of the invention the specified query options determines whether a query option is computationally-expensive, and if the query option is computationally expensive the query option may include a join and a select-project-join-aggregate group-by block execution.

In a related aspect of the invention the data storage system is a virtualized storage area network.

In a related aspect of the invention, no tuples are shipped between nodes.

In a related aspect of the invention, the method further comprises retrieving data from the data storage system by the individual computing nodes when needed.

In a related aspect of the invention, the data is indexed when it is read-only.

In a related aspect of the invention, the query processing includes a computer program saved on a computer-readable medium.

In a related aspect of the invention the method further comprises determining the relative processing power of the individual computing nodes using a grid load monitor.

In a related aspect of the invention the method further comprises reassigning a query fragment of the specified query operation on a first individual computing node to a second individual computing node when the first individual computing node fails by not responding after a specified period of time.

In a related aspect of the invention the allocating of query fragments of the specified query operation is divided substantially equally to the individual computing nodes.

In a related aspect of the invention the query fragments are divided according to the use of a linear program when the computing nodes have different processing capabilities.

### DETAILED DESCRIPTION OF THE INVENTION

The present invention provides a query processing system for dynamically using non-dedicated and heterogeneous external compute resources (computer nodes) for running a query in parallel, without any re-partitioning and without any tuple shipping between join operators. The present invention runs independent SQL queries on the processing nodes, with no tuple shipping between the query processors.

The method of the present invention also dynamically detects failures or load bursts at the external compute resources (computer nodes), and upon detection, re-assigns parts of the query operations to other computer nodes so as to minimize disruption to the overall query. The present invention addresses the problem of using non-dedicated and heterogeneous computers for parallel query processing.

The method of the present invention applies to select-project-join-aggregate-group by (SPJAG) blocks, whose execution is typically the major component of the overall query execution time. A “Select-Project-Join-Aggregate-Group By” is a structure that arises within an SQL query. The structure may combine selected record in multiple tables to form a sum aggregate of the records.

The execution of SPJAG blocks in a query is pushed down by the query processor, to a specialized module according to the invention, called a cpuwrapper. Pushing down the query by the query processor includes the query processor delegating some portion of the query to other components, which in the embodiment the present invention is the cpuwrapper. The cpuwrapper in turn outsources the SPJAG operation to autonomous co-processor computer nodes that have access to a shared storage system 62 (e.g, a distributed file system). In a preferred embodiment the distributed file system is a SAN (storage area network) file system. A storage area network (SAN) is a network designed to attach computer storage devices such as, a disk array controller and/or tape libraries to servers. A SAN may also include a network whose primary purpose is the transfer of data between computer systems and storage elements. The present invention can re-evaluate a node that has stalled, and/or re-adjust workload as data is still on the SAN.

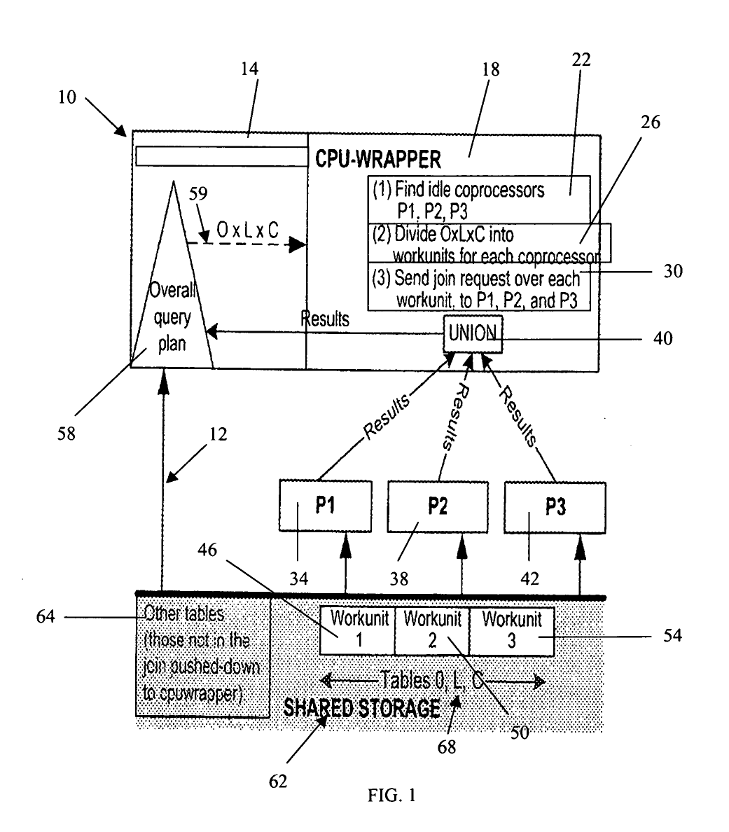

Referring to FIG. 1, “Data In The Network” (DITN) system architecture 10 includes a main virtualization component which is the cpuwrapper 18. The OLC tables 68 are a portion of the overall query plan 58 that can be delegated to the cpuwrapper, as shown in FIG. 1, and added as indicated by arrow 59 to the cpuwrapper 18. An information integrator 14 (integrator) manages the overall query plan and feeds the cpuwrapper 18. The cpuwrapper 18 has three main functions: (1) to find idle coprocessors, e.g., P1, P2, P3, 34, 38, 42, respectively; (2) divide OLC tables 68 in the shared storage area 62 into workunits, for example, workunits 1, 2, 3, (46, 50, 54, respectively), for each coprocessor 34, 38, 42; (3) sending join requests over each workunit in the shared storage 62 to co-processors P1,P2,P3, 34,38,42, respectively; and (4) union 40 the joined results.

More specifically, integrator 14 uses wrappers to obtain a relational access interface to heterogeneous data sources. During a dynamic-program optimization phase, the integrator 14 repeatedly tries to “push down” various plan fragments to the wrappers, and chooses the extent of the push down so as to minimize the overall plan cost. The cpuwrapper 18 is specifically designed to wrap compute nodes, not only data sources. The compute nodes are co-processors P1, P2, P3, 34, 38, 42, respectively.

The integrator 14 views the cpuwrapper 18 as a wrapper over a single data source, “GRID”. The integrator 14 tries to push down various plan fragments to the cpuwrapper, but the only ones that the cpuwrapper accepts are select-project-join fragments with aggregation and group by (SPJAG). Other, more complex fragments are returned back to the integrator 14 as not pushdownable to the “GRID” source, and performed at the integrator 14 node itself. The GRID is the collection of all the computing nodes available, or equivalent to the cpuwrapper in the present invention. For example, in FIG. 1, the OLC 68 join alone is pushed down to the cpuwrapper 18, the rest of the query plan is done by the integrator 14.

When the integrator 14 pushes down SPJAGs to the cpuwrapper 18, the cpuwrapper executes them by outsourcing the work to the co-processors P1, P2, P3, 34, 38, 42, respectively. The outsourcing provides: (a) identification of idle co-processors using a grid load monitor; (b) logically splitting the input tables into work-units; (c) rewriting the overall SPJAG as a union of SPJAGs over the work-units; and (d) executing these SPJAGs in parallel on the co-processors. In step (d), the cpuwrapper detects and handles dynamic load-bursts and failures, by reassigning delayed work-units to alternative co-processors.

According to an embodiment of the present invention the steps for outsourcing the SPJAG operation to autonomous co-processor nodes includes:

Step one: the cpuwrapper contacts a grid load monitor to inquire about spare compute nodes (computer nodes; co-processors; or a plurality of individual computing nodes), and the current CPU loads data on these nodes. The compute nodes must all have access to a common data storage system for storing data, and they must all have join processing code installed. Further, the compute nodes can retrieve data from the common data storage system as needed. The grid load monitors the computational performance of an individual computing node and the cpuwrapper may reassign the query fragments to selected nodes based on the nodes performance, e.g., the CPU load.

Step two: if necessary, the cpuwrapper specially prepares the input tables for the SPJAG operation. The preparations include ensuring isolation from concurrent updates, and to ensure that the input tables are accessible to all the co-processors on shared storage 62, and to cluster the tables for efficient join execution.

Step three: the cpuwrapper logically splits the prepared input tables into work-units, such that the output of the SPJAG on the input tables equals the union of the SPJAG on each work-unit (in many cases aggregations and group-bys are also pushed down and may have to be re-applied). The cpuwrapper optimizes the division into work-units and allocates the work-units to co-processors so as to minimize the query response time. When the co-processors are not identical, the cpuwrapper formulates and uses a linear program to minimize the response time of the query when allocating work to processor having different capabilities.

Step four: the cpuwrapper sends the SPJAG request to the co-processors as separate SQL queries (query fragments), and the co-processors (computing nodes determined to have the best computing capability) perform the SPJAG over their respective work-units, in parallel, independently executing the query fragment. The co-processors read their work-units directly from the data storage system. The method does not require heterogeneous computing nodes. The cpuwrapper can manage with homogeneous or heterogeneous computing nodes. The method of the present invention allows each node to run a different query plan for the query fragment assigned to it. The query fragment is assigned as SQL, thus, each computing node has the flexibility to use its' query optimizer and choose a suitable query plan for its fragment.

Step five: the cpuwrapper handles the dynamic failure/slowdown of co-processors by waiting a certain fraction of time after all but one of the co-processors have finished. At this time, the cpuwrapper considers the laggard co-processor (for example, co-processor A) as failed, and reassigns its work to one of the other co-processors (for example, co-processor B) that has finished. Either co-processor A or B can finish first, whereupon, the cpuwrapper cancels the processing at the other co-processor (if possible).

Step six: the cpuwrapper unions 40 (shown in FIG. 1) the results it receives from the co-processors, and returns them to the higher operator in the query plan as they arrive (using separate threads or through asynchronous input/output (I/O)). The union 40 is a collection of tuples by each of the co-processors P1 34, P2 38, P3 42. The query fragments are thus combined to produce a final query result.

If the database is read-only (or a read-only replica of a read-write database that is currently not being synchronized), the input tables need no preparation. Furthermore, if the application can tolerate Uncommitted Read (UR) semantics (e.g. a decision support application that aggregates information from large numbers of records, and whose answer is not significantly affected by uncommitted results in a small fraction of these records), there is no need for preparation. However, in all other situations, the cpuwrapper sends to each co-processor the range of data pages it must process from each table or a portion of the query processing. Then the query processing code on the co-processor scans these data pages without acquiring any locks. Note that this code cannot use any indexes on the main database to access the input tables. In one instance, queries could see stale versions of some of the pages, e.g, a page could have been updated by a committed transaction but the committed version may not have been written to disk. The user can mitigate the degree of staleness by adjusting the frequency with which buffer pool pages are flushed.

If Uncommitted Read (UR) semantics is not enough, the CPU wrapper can issue a query (under the same transaction) to create a read-only copy of the input tables on the shared storage system 62. This copy can be either a database table itself, or a file. A file is preferable because it helps with efficient access from the storage system. This read-only copy need not be created separately for each query. Many queries may tolerate a relaxed semantics where they are executed on a cached copy of the input tables. For workloads with such queries, the overhead of creating the new copy is amortized over several queries.

The cpuwrapper 18 or metawrapper identifies expensive operations, sends separate SQL queries to individual nodes. The method dynamically detects processor speed, and optimally allocates nodes to a job.

The method of the present invention solves the problem of non-dedicated compute resources by viewing them as a central processing unit (CPU) only. The data is accessed from a shared storage 62. Since network bandwidths have become significantly larger than the bandwidth of query operators, especially over local areas, it is profitable to dynamically exploit remote compute resources to improve query performance, even if the data is not already partitioned there. The method of the present invention uses heterogeneous compute resources by parallelizing the resources, at an intra-fragment granularity that does not ship tuples between query operators or nodes (compute nodes). Thus, each co-processor can run its own query plan, and its own version of the DBMS.

The method of the present invention allocates work units to compute resources during query execution. This has the advantage of assigning query fragments to compute nodes with full awareness of the latest CPU and network load, at the time the query fragment is run. The method of the present invention also provides for the allocation of work units of a join operation to heterogeneous compute nodes that optimizes for response time by formulating the join operation as a linear program.

The method of the present invention further provides a solution for dynamic failures or stalls of the compute nodes by reassigning work. This ensures that the query is not bound by the speed of the slowest compute node.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A method for query processing in a grid computing infrastructure, comprising:
storing data in a data storage system accessible to a plurality of individual computing nodes;
identifying specified query operations;
allocating query fragments of a specified query operation to the individual computing nodes according to each of the individual computing nodes computing capability;
independently executing the query fragments on the individual computing nodes in parallel to increase speed of query execution; and
combining the query fragment results into a final query result.

2. The method of claim 1 further comprising:
monitoring computational performance of the individual computing nodes; and
selectively reassigning the query fragments to particular individual computing nodes according to changes in performance of the monitored nodes.

3. The method of claim 1 wherein the individual computing nodes include non-dedicated heterogeneous computing nodes each running different database applications.

4. The method of claim 1 wherein one of the specified query options determines whether a query option is computationally-expensive.

5. The method of claim 4 wherein the computationally expensive query option includes a join and a select-project-join-aggregate group-by block execution.

6. The method of claim 1 wherein the data storage system is a virtualized storage area network.

7. The method of claim 1 wherein no tuples are shipped between nodes.

8. The method of claim 1 further comprising:
retrieving data from the data storage system by the individual computing nodes when needed.

9. The method of claim 1 wherein the data is indexed when it is read-only.

10. The method of claim 1 wherein the query processing includes a computer program saved on a computer-readable medium.

11. The method of claim 1 further comprising determining the relative processing power of the individual computing nodes using a grid load monitor.

12. The method of claim 1 further comprising reassigning a query fragment of the specified query operation on a first individual computing node to a second individual computing node when the first individual computing node fails by not responding after a specified period of time.

13. The method of claim 1 wherein the allocating of query fragments of the specified query operation is divided substantially equally to the individual computing nodes.

14. The method of claim 1 wherein the query fragments are divided according to the use of a liner program when the computing nodes have different processing capabilities.
